(19) United States
(12) Patent Application Publication
(10) Pub. No.: US 2023/0378620 A1
(43) Pub. Date: Nov. 23, 2023

(54) POUCH-TYPE BATTERY CELL, AND BATTERY CELL ASSEMBLY AND BATTERY PACK HAVING THE SAME

(71) Applicant: SK On Co., Ltd., Seoul (KR)

(72) Inventors: Seo Roh RHEE, Daejeon (KR); Ji San KIM, Daejeon (KR); Tak Kyung YOO, Daejeon (KR); Chang Mook HWANG, Daejeon (KR)

(21) Appl. No.: 18/316,232

(22) Filed: May 12, 2023

(30) Foreign Application Priority Data
May 18, 2022 (KR) 10-2022-0060884

(51) Int. Cl. H01M 50/533; H01M 50/105; H01M 50/188; H01M 50/178; H01M 50/507; H01M 50/211

(52) U.S. Cl. CPC H01M 50/533; H01M 50/105; H01M 50/188; H01M 50/178; H01M 50/507; H01M 50/211

(57) ABSTRACT

A pouch-type battery cell includes an electrode assembly formed by stacking a plurality of electrode plates, a pouch having an electrode accommodating portion accommodating the electrode assembly therein and a sealing portion sealing at least a portion of a circumference of the electrode accommodating portion, and electrode leads electrically connected to the electrode assembly and exposed to an outside of the pouch through the sealing portion. The electrode leads are exposed to the outside of the pouch through a first sealing portion formed at a corner of the pouch among the sealing portion.

### CROSS-REFERENCE TO RELATED APPLICATION(S)

This patent document claims the priority and benefits of Korean Patent Application No. 10-2022-0060884 filed in the Korean Intellectual Property Office on May 18, 2022, the disclosure of which is incorporated herein by reference in its entirety.

### TECHNICAL FIELD

The present disclosure relates to a battery cell comprised of a secondary battery, and a battery cell assembly and a battery pack having the same, and more particularly, to a pouch-type battery cell, and a battery cell assembly including a plurality of pouch-type battery cells, and a battery pack including a plurality of battery cell assemblies.

### BACKGROUND

Unlike primary batteries, secondary batteries may be charged and discharged, and may thus be applied to devices within various fields such as digital cameras, mobile phones, laptop computers, hybrid vehicles, and electric vehicles. Secondary batteries include lithium secondary batteries, nickel-cadmium batteries, nickel-metal hydride batteries, nickel-hydrogen batteries, and the like.

Among these secondary batteries, many studies into lithium secondary batteries having high energy density and discharge voltage are in progress. Recently, lithium secondary batteries are manufactured as flexible pouch-type battery cells or rigid prismatic or cylindrical can-type battery cells. A plurality of battery cells are electrically connected and used.

In the pouch-type battery cell according to the related art, an electrode assembly is accommodated inside the pouch. A pouch-type battery cell of the related art has a structure in which sealing portions are formed on both sides of the pouch in the longitudinal direction (width direction) and electrode leads extend from both sides of the pouch in the longitudinal direction to the outside of the sealing portion. Therefore, in the pouch-type battery cell of the related art, the electrode plate is not formed by the sum of the width of the sealing portion and the protruding length of the electrode lead, on both sides of the pouch in the longitudinal direction, respectively. For example, the length (width) of the region where the electrode plate is not formed on one side where the electrode lead is exposed is about 20 mm. Since the electrode leads are disposed on both sides of the pouch in the longitudinal direction, the length (width) of the region where the electrode plate is not formed on both sides of the pouch in the longitudinal direction is about 40 mm.

As described above, in the pouch-type battery cell of the related art, the ratio of the portion where the electrode plate is not installed is relatively large among the total area (volume) in which the battery cell is installed, and thus, a lot of capacity loss occurs. Accordingly, there is a problem in that the energy density per unit volume cannot be sufficiently increased. In addition, the electrode leads are welded to the bus bar on both sides of the pouch in the longitudinal direction, and since space is required to install a structure (bus bar support member) for bus bar insulation, there is a problem in that capacity loss additionally occurs.

On the other hand, in recent years, demand for rapid charging has increased in various fields such as battery systems for electric vehicles. For rapid charging, the resistance of the battery cell should be lowered. To this end, it is necessary to increase the height of the electrode lead (the width of the portion perpendicular to the longitudinal direction of the pouch). However, in the case of a pouch-type battery cell according to the related art, the height of the electrode lead is inevitably smaller than the height of the battery cell. In particular, in order to electrically connect a plurality of battery cells, extra space is required to connect the electrode leads to the bus bar. Thus, the height of the electrode lead should be sufficiently smaller than the height of the battery cell. Therefore, the pouch-type battery cell according to the related art has limitations in increasing the height of the electrode lead, and has a problem in which it cannot sufficiently respond to rapid charging.

### SUMMARY

An aspect of the present disclosure is to provide a pouch-type battery cell for improving energy density per unit volume, a battery cell assembly and a battery pack having the same.

An aspect of the present disclosure is to provide a pouch-type battery cell advantageous for rapid charging, a battery cell assembly and a battery pack having the same.

According to an aspect of the present disclosure, the width of an electrode lead may increase.

According to an aspect of the present disclosure, current flow from electrode plates to electrode leads may be improved.

According to an aspect of the present disclosure, damage to electrode leads may be reduced.

According to an aspect of the present disclosure, the assemblability of bus bar assemblies may be improved.

According to an aspect of the present disclosure, a pouch-type battery cell includes an electrode assembly formed by stacking a plurality of electrode plates; a pouch having an electrode accommodating portion accommodating the electrode assembly therein and a sealing portion sealing at least a portion of a circumference of the electrode accommodating portion; and electrode leads electrically connected to the electrode assembly and exposed to an outside of the pouch through the sealing portion. The electrode leads are exposed to the outside of the pouch through a first sealing portion formed at a corner of the pouch among the sealing portion.

The electrode assembly may have an inclined portion having a chamfered shape in at least some corners, and the electrode leads may be electrically connected to the electrode assembly through the inclined portion.

Each of the plurality of electrode plates may have at least six sides including a first long side, the pouch may have a folded shape based on a portion corresponding to the first long side of the electrode assembly, and the sealing portion may be provided on a remaining portion of a circumference of the electrode assembly, except for a portion thereof corresponding to the first long side.

Each of the plurality of electrode plates may include the first long side, two short sides perpendicular to the first long side, a second long side facing the first long side, and two inclined sides connecting the second long side and the two short sides, respectively.

Each of the plurality of electrode plates may have a shape in which at least a portion of corners of a quadrangle having a long side and a short side is chamfered, and the electrode assembly may include long side parts corresponding to long sides of the plurality of electrode plates, short side parts corresponding to short sides of the plurality of electrode plates, and inclined portions connecting the long side parts and the short side parts.

The inclined portions may be disposed on both sides of one of the long side parts, respectively.

The sealing portion may include the first sealing portion and a second sealing portion, the second sealing portion being formed corresponding to at least a portion of the long side parts and the short side parts.

The second sealing portion may include a long side sealing portion corresponding to the long side part and a short side sealing portion corresponding to the short side part, and the long side sealing portion may be folded at least once.

The short side sealing portion may be folded at least once.

The pouch may have a folded shape based on a portion of the electrode accommodating portion, which corresponds to one of the long side parts of the electrode assembly.

The electrode leads may have a shape extending in a direction perpendicular to the inclined portions.

The electrode accommodating portion may have a shape corresponding to the electrode assembly, and the sealing portion may seal at least a portion of the circumference of the electrode accommodating portion in a shape corresponding to the electrode assembly.

According to an aspect of the present disclosure, a battery cell assembly includes a plurality of pouch-type battery cells each including an electrode assembly formed by stacking a plurality of electrode plates, a pouch having an electrode accommodating portion accommodating the electrode assembly therein and a sealing portion sealing at least a portion of a circumference of the electrode accommodating portion, and electrode leads electrically connected to the electrode assembly; and a bus bar assembly having at least one bus bar electrically connected to the electrode leads. The electrode leads are exposed to an outside of the pouch through a first sealing portion provided at a corner of the pouch among the sealing portion.

The electrode assembly may have an inclined portion having a chamfered shape in at least some corners, and the electrode leads may be electrically connected to the electrode assembly through the inclined portion.

Each of the plurality of electrode plates may have a shape in which at least a portion of corners of a quadrangle having a long side extending in a first direction and a short side extending in a second direction is chamfered, and the electrode assembly may include long side parts corresponding to long sides of the plurality of electrode plates, short side parts corresponding to short sides of the plurality of electrode plates, and inclined portions connecting the long side parts and the short side parts.

The electrode leads may have a shape extending in a direction perpendicular to the inclined portion.

The at least one bus bar may include a coupling hole to which each of the electrode leads may be coupled, and each of the electrode leads may include a first end coupled to the coupling hole while passing through the coupling hole in the first direction, and a second end coupled to the coupling hole while passing through the coupling hole in the second direction.

The bus bar may include a first coupling surface to which the first end may be coupled and a second coupling surface to which the second end may be coupled, and the coupling hole may have a shape extending over the first coupling surface and the second coupling surface.

The at least one bus bar may include an inclined coupling surface having a coupling hole through which each of the electrode leads passes and is coupled thereto, and the inclined coupling surface may form an inclination with respect to a surface perpendicular to the first direction and a surface perpendicular to the second direction, respectively.

According to an aspect of the present disclosure, a battery pack includes the battery cell assembly described above; and a pack housing having an inner space in which a plurality of the battery cell assemblies are accommodated.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a pouch-type battery cell according to an embodiment of the present disclosure.

FIG. 2 is an exploded perspective view of the pouch-type battery cell illustrated in FIG. 1;

FIG. 3 is a front view of the pouch-type battery cell illustrated in FIG. 1;

FIG. 4 is a perspective view illustrating a modified example of the pouch-type battery cell illustrated in FIG. 1;

FIG. 5 is an explanatory diagram for the contrast between the pouch-type battery cell illustrated in FIG. 1 and a pouch-type battery cell according to the related art;

FIG. 6 is a perspective view of a battery cell assembly according to an embodiment of the present disclosure;

FIG. 7 is an enlarged view of portion “A” in FIG. 6;

FIGS. 8 and 9 are perspective views illustrating various assembly directions of the bus bar assembly;

FIG. 10 is an exploded perspective view illustrating a modified example of the battery cell assembly illustrated in FIG. 6; and

FIG. 11 is an exploded perspective view of a battery pack according to an embodiment of the present disclosure.

### DETAILED DESCRIPTION

Prior to the detailed description of the present disclosure, the terms or words used in the present specification and claims described below should not be construed as being limited to related art or dictionary meanings. Based on the principle that an inventor may appropriately define the concept of a term to best describe his invention, the terms or words used in the present specification and claims described below should be interpreted as meaning and concept consistent with the technical spirit of the present disclosure. Therefore, the configurations illustrated in the embodiments and drawings described in this specification are only the exemplary embodiments of the present disclosure, and do not represent all of the technical spirit of the present disclosure, and it should be understood that various equivalents and modifications may be substituted therefor at the time of filing the present application.

Hereinafter, embodiments will be described in detail with reference to the accompanying drawings. In this case, it should be noted that the same components in the accompanying drawings are denoted by the same reference numerals as much as possible. In addition, detailed descriptions of well-known functions and configurations that may obscure the gist of the present disclosure will be omitted. For the same reason, some components are exaggerated, omitted, or schematically illustrated in the accompanying drawings, and the size of each component does not fully reflect the actual size thereof.

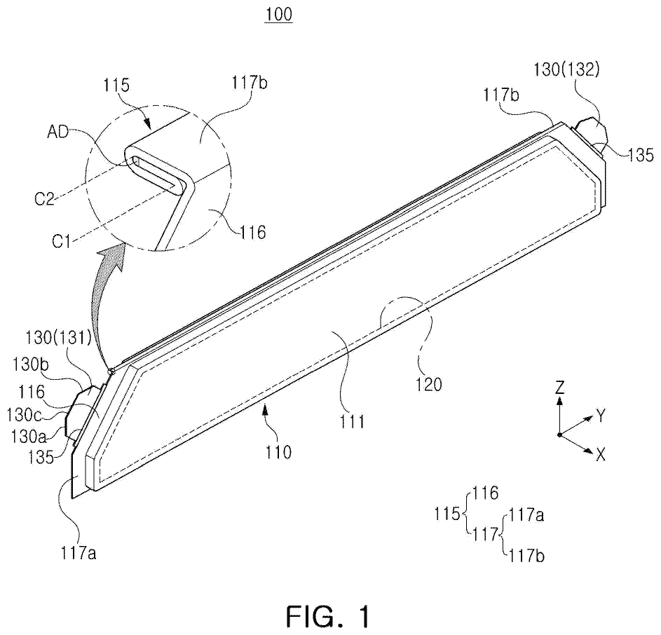

First, a pouch-type battery cell 100 according to an embodiment of the present disclosure will be described with reference to FIGS. 1 to 5.

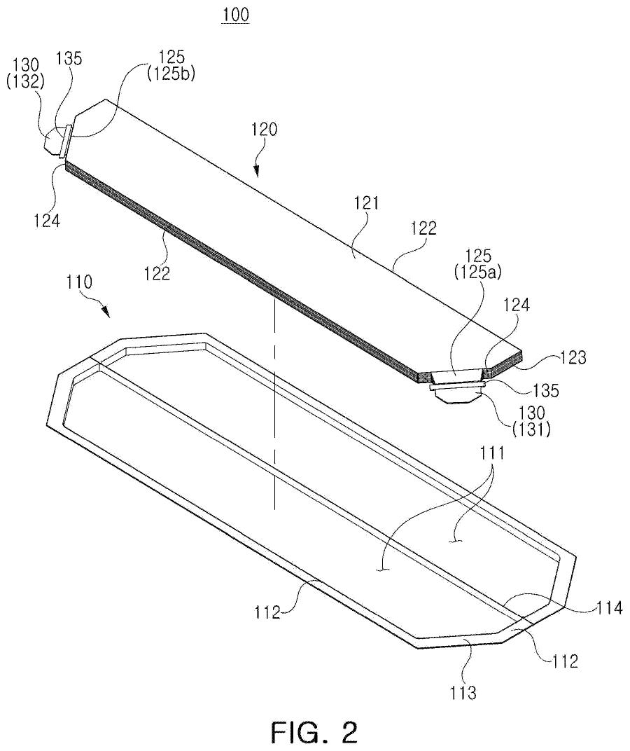

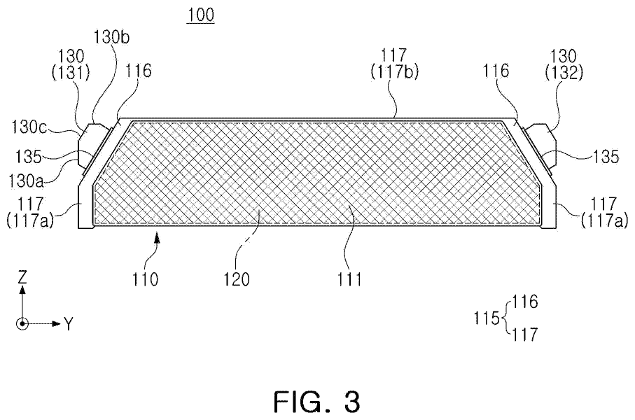

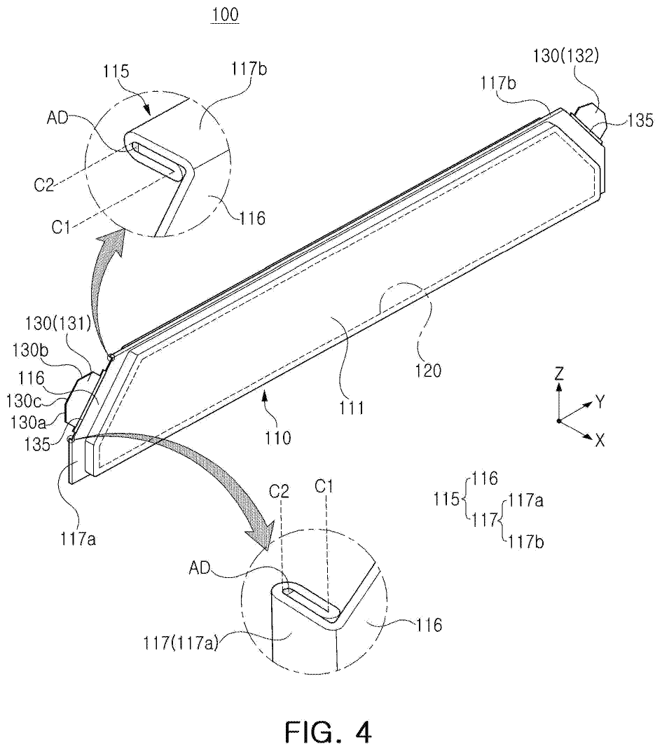

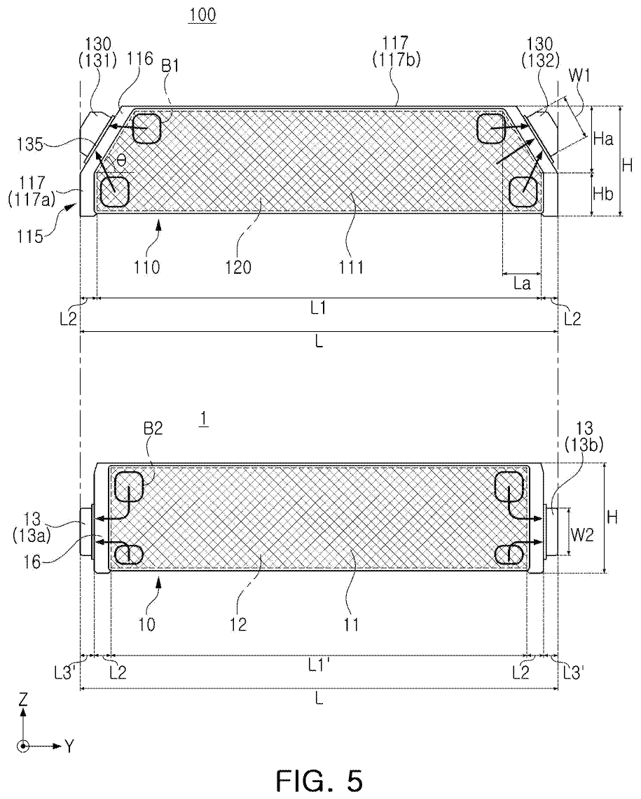

FIG. 1 is a perspective view of a pouch-type battery cell 100 according to an embodiment of the present disclosure, FIG. 2 is an exploded perspective view of the pouch-type battery cell 100 illustrated in FIG. 1, FIG. 3 is a front view of the pouch-type battery cell 100 illustrated in FIG. 1, FIG. 4 is a perspective view illustrating a modified example of the pouch-type battery cell 100 illustrated in FIG. 1, and FIG. 5 is an explanatory diagram for a contrast between the pouch-type battery cell 100 illustrated in FIG. 1 and a pouch-type battery cell 1 according to the related art.

Referring to FIGS. 1 to 3, the pouch-type battery cell 100 according to an embodiment of the present disclosure may include a pouch 110, an electrode assembly 120, and a plurality of electrode leads 130.

The pouch-type battery cell 100 according to an embodiment of the present disclosure is formed of a secondary battery capable of charging and discharging, and may have a form in which the electrode assembly 120 and the electrolyte are accommodated in the pouch 110. As an example, the pouch-type battery cell 100 may be formed of a lithium ion (Li-ion) battery or a nickel metal hydride (Ni-MH) battery, but the type is not limited thereto.

The pouch 110 may be formed of a multi-layer film casing including a material such as aluminum. The pouch 110 may include an electrode accommodating portion 111 corresponding to a space in which the electrode assembly 120 is accommodated, and a sealing portion 115 formed by sealing at least a portion of the circumference of the electrode accommodating portion 111.

The electrode accommodating portion 111 is formed in a container shape to accommodate the electrode assembly 120 and has a shape corresponding to the outer shape of the electrode assembly 120. The electrode accommodating portion 111 may have a slightly larger size than the size of the electrode assembly 120 to accommodate the electrode assembly 120. The electrode assembly 120 and the electrolyte are accommodated in the inner space of the electrode accommodating portion 111.

The electrode accommodating portion 111 may be formed by forming one or two sheets of film casing. For example, the electrode accommodating portion 111 having a recessed shape may be formed on both sides of the central portion 114 by forming a sheet of film casing. When the film casing is folded based on the central portion 114, the pair of electrode accommodating portions 111 form a space in which the electrode assembly 120 is accommodated. Flange portions 112 and 113 may be formed around the electrode accommodating portion 111. The flange portions 112 and 113 may be formed in an area of the circumference of the electrode accommodating portion 111 excluding the central portion 114. The flange portions 112 and 113 may have a shape corresponding to the rim of the electrode accommodating portion 111. The flange portions 112 and 113 extend toward the outside of the electrode accommodating portion 111 and have a predetermined width. Unlike the above, the electrode accommodating portion 111 may be formed by forming two sheets of film casing, in which case the flange portions 112 and 113 may be formed around the entire circumference of the electrode accommodating portion 111.

The sealing portion 115 is a portion that seals at least a portion of the circumference of the electrode accommodating portion 111. The sealing portion 115 may seal at least a portion of the circumference of the electrode accommodating portion 111 in a shape corresponding to the electrode assembly 120. For example, the sealing portion 115 may be formed by sealing the flange portions 112 and 113 along the circumference of the electrode accommodating portion 111. The sealing portion 115 blocks the electrode assembly 120 accommodated in the electrode accommodating portion 111 from the outside. A thermal fusion method may be used to bond the film casing for forming the sealing portion 115, but the present disclosure is not limited thereto.

The electrode assembly 120 includes a plurality of electrode plates 121 and a separator (not illustrated), and is accommodated in the electrode accommodating portion 111 of the pouch 110. The electrode plate 121 may have a size and shape corresponding to that of the electrode accommodating portion 111. Since the electrode plate 121 is accommodated inside the electrode accommodating portion 111, the size of the electrode plate 121 may be slightly smaller than that of the electrode accommodating portion 111.

The electrode plate 121 may include a cathode plate and an anode plate. The cathode plate and the anode plate are alternately stacked, and a separator is interposed between the cathode and anode plates.

An electrode tab 125 may be connected to each electrode plate 121. The electrode tab 125 functions as a current collector and may be formed of a foil. A positive electrode tab 125a may be connected to the cathode plate, and a negative electrode tab 125b may be connected to the anode plate.

The plurality of electrode tabs 125 may be connected to the electrode lead 130 having the same polarity by gathering the same polarities. For example, the ends of the plurality of positive electrode tabs 125a may be gathered and connected to the positive electrode lead 131, and the ends of the plurality of negative electrode tabs 125b may be gathered and connected to the negative electrode lead 132.

The electrode lead 130 may be electrically connected to the electrode assembly 120 through the electrode tab 125. The electrode lead 130 may be exposed to the outside of the pouch 110 through the sealing portion 115 such that the electrode assembly 120 may be electrically connected to the outside of the pouch 110.

Each of the plurality of electrode plates 121 may have a shape in which at least a portion of the corners of a quadrangle (e.g., a rectangle) having long sides and short sides are chamfered. Since the electrode assembly 120 has a form in which a plurality of electrode plates 121 are stacked, the inclined portion 124 having a chamfered shape may be formed at at least some of the corners like each electrode plate 121. In detail, the electrode assembly 120 may include a long side part 122 corresponding to the long side of the plurality of electrode plates 121, a short side part 123 corresponding to the short side of the plurality of electrode plates 121, and an inclined portion 124 connecting the long side part 122 and the short side part 123. For example, the inclined portion 124 corresponds to the chamfered portion among the corners of the quadrangle.

The inclined portion 124 may be formed on both sides of either one of the long side parts 122 among the two long side parts 122, respectively. The electrode tabs 125 may be connected to the inclined portions 124 on both sides, respectively. For example, the positive electrode tab 125a may be connected to the inclined portion 124 on one side, and the negative electrode tab 125b may be connected to the inclined portion 124 on the other side. The positive electrode lead 131 may be connected to the positive electrode tab 125a, and the negative electrode lead 132 may be connected to the negative electrode tab 125b.

In addition, each of the plurality of electrode plates 121 may have at least six sides, including a first long side. For example, each of the plurality of electrode plates 121 may include the first long side, two short sides perpendicular to the first long side, a second long side facing the first long side, and two inclined sides connecting the second long side and the two short sides, respectively. The pouch 110 may have a folded shape folded according to a portion corresponding to the first long side of the electrode assembly 120. For example, the pouch 110 may have a folded shape based on the long side part 122 having a longer length among the two long side parts 122.

The electrode accommodating portion 111 and the flange portions 112 and 113 may have shapes corresponding to the electrode assembly 120. For example, the electrode accommodating portion 111 and the flange portions 112 and 113 may also have shapes corresponding to the inclined portion 124. The flange portions 112 and 113 formed around the electrode accommodating portion 111 include a first flange 113 corresponding to the inclined portion 124 and a second flange 112 corresponding to the long side part 122 and the short side part 123.

The sealing portion 115 is formed on the flange portions 112 and 113, and may thus have a shape corresponding to the flange portions 112 and 113. The sealing portion 115 may be divided into a first sealing portion 116 where the electrode lead 130 is disposed and a second sealing portion 117 where the electrode lead 130 is not disposed. The first sealing portion 116 is a portion corresponding to the inclined portion 124 of the electrode assembly 120, and the second sealing portion 117 is a portion corresponding to at least a portion of the short side part 123 and the long side part 122 of the electrode assembly 120. The first sealing portion 116 is formed at a corner of the pouch 110 and may be disposed between the second sealing portions 117. The second sealing portion 117 may include a long side sealing portion 117b corresponding to the long side part 122 and a short side sealing portion 117a corresponding to the short side part 123. In the case of forming the electrode accommodating portion 111 using one sheet of film casing, the pouch 110 may have a folded shape based on a portion corresponding to one of the long side parts 122 of the electrode accommodating portion 111, for example, the long side part 122 having a relatively longer length. In this case, the sealing portion 115 may be formed on the rest of the circumference of the electrode assembly 120 except for the long side part 122 corresponding to one long side. The sealing portion 115 may include two short side sealing portions 117a and one long side sealing portion 117b. Since one long side part 122 corresponds to the central portion 114 of the film casing and is folded, the sealing portion 115 is not formed on one long side part 122. However, when the electrode accommodating portion 111 is formed using two sheets of film casing, the second sealing portion 117 may include two short side sealing portions 117a and two long side sealing portions 117b.

In an embodiment of the present disclosure, at least a portion (115) of the sealing portions may be formed in a folded shape at least once. In this case, the bonding reliability of the sealing portion 115 may be increased and the volume occupied by the sealing portion 115 may be significantly reduced.

Since the electrode lead 130 is not disposed on the second sealing portion 117, the second sealing portion 117 may have a structure that is folded at least once. At least some of the long side sealing portion 117b and the short side sealing portion 117a may be folded at least once.

In an embodiment, the long side sealing portion 117b may be fixed by an adhesive member AD after being folded twice. For example, the long side sealing portion 117b may be folded 180° along the first bending line C1 and then again folded along the second bending line C2. The adhesive member AD may be filled in the long side sealing portion 117b. The long side sealing portion 117b may maintain a twice-folded shape by the adhesive member AD. The adhesive member AD may be formed of an adhesive having high thermal conductivity. For example, the adhesive member AD may be formed of epoxy or silicon, but is not limited thereto.

The electrode lead 130 may be exposed to the outside of the pouch 110 through the first sealing portion 116. The electrode lead 130 may be electrically connected to the inclined portion 124 of the electrode assembly 120 through the electrode tab 125. The electrode lead 130 may include a positive electrode lead 131 connected to the positive electrode tab 125a disposed on one side of the inclined portion 124, and a negative electrode lead 132 connected to the negative electrode tab 125b disposed on the other side of the inclined portion 124. At least one surface of the electrode lead 130 may be covered with an insulating film 135 to increase the degree of sealing of the first sealing portion 116 in the position where the electrode lead 130 is drawn out and to secure an electrical insulation state at the same time.

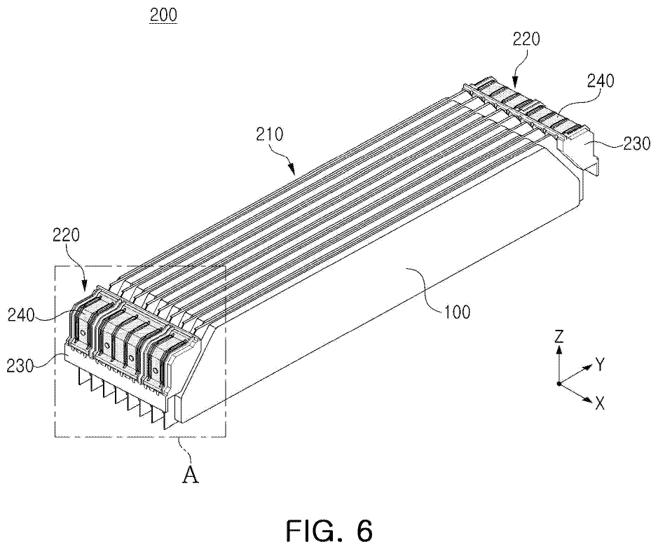

The electrode lead 130 may extend in a direction perpendicular to the inclined portion 124. As will be described later, the electrode lead 130 may have a shape and size passing through a coupling hole (241 in FIG. 6) of a bus bar (240 in FIG. 6). An end of the electrode lead 130 may be welded to the bus bar 240 while being disposed to pass through the coupling hole 241.

An end of the electrode lead 130 may have a shape corresponding to the shape of the bus bar 240 and the coupling hole 241. For example, the electrode lead 130 may include a first end 130a and a second end 130b respectively coupled to the coupling hole 241. The first end 130a and the second end 130b may be connected by a connection end 130c.

On the other hand, the electrode lead 130 may be in a state where the end of the electrode lead 130 unnecessarily extends to the outside of the coupling hole 241 in a state in which it is coupled to the bus bar 240, and an unnecessary end of the electrode lead 130 in a state welded to the bar 240 may be removed by cutting. Therefore, in an embodiment of the present disclosure, the shape of the end means a state in which the electrode lead 130 is coupled to the bus bar 240 and then finished. A detailed description of the end shape of the electrode lead 130 will be described later.

A detailed description of the end shape of the electrode lead 130 will be described later.

Next, with reference to FIG. 4, a modified example of the pouch-type battery cell 100 illustrated in FIG. 1 will be described.

A pouch-type battery cell 100 illustrated in FIG. 4 has substantially the same configuration as the pouch-type battery cell 100 illustrated in FIG. 1 except that the short side sealing portion 117a has a structure in which it is folded at least once. Therefore, to avoid unnecessary duplication, detailed descriptions of the same or similar components will be omitted and replaced with the above description.

In an embodiment illustrated in FIG. 4, the long side sealing portion 117b and the short side sealing portion 117a may have a structure in which they are folded at least once. In this case, not only the long side sealing portion 117b but also the short side sealing portion 117a may increase the reliability of the connection of the sealing portion 115, and the volume occupied by the short side sealing portion 117a may be significantly reduced.

In an embodiment, the short side sealing portion 117a may be fixed by an adhesive member AD after being folded twice. For example, the short side sealing portion 117a may be folded 180° along a first bending line C1 and then again folded along a second bending line C2. The adhesive member AD may be filled in the short side sealing portion 117a. The short side sealing portion 117a may maintain a twice-folded shape by the adhesive member AD. The adhesive member AD may be formed of an adhesive having high thermal conductivity. For example, the adhesive member AD may be formed of epoxy or silicon, but is not limited thereto.

FIG. 5 is an explanatory diagram for contrast between the pouch-type battery cell 100 illustrated in FIG. 1 and the pouch-type battery cell 1 according to the related art. In FIG. 5, the upper portion schematically illustrates the structure of a pouch-type battery cell 100 according to an embodiment of the present disclosure, and the lower portion schematically illustrates the structure of the pouch-type battery cell 1 according to the related art. The pouch-type battery cell 1 according to the related art includes a pouch 10, an electrode assembly 12, and an electrode lead 13, and the pouch 10 includes an electrode accommodating portion 11 in which the electrode assembly 12 is accommodated, and a sealing portion 16. The positive electrode lead 13a and the negative electrode lead 13b constituting the electrode lead 13 have a configuration disposed on both ends of the pouch 10, respectively.

For contrast therebetween, it is assumed that the pouch-type battery cell 100 according to an embodiment of the present disclosure and the pouch-type battery cell 1 according to the related art have the same length (width) (L) and height (H) and the widths L2 of the sealing portions 117a and 16 are the same.

In an embodiment of the present disclosure, the length (width) L1 of the region in which the electrode assembly 120 is installed is a value (i.e., L1=L−2L2) obtained by subtracting the lengths L2 of the second sealing portions 117 and 117a located on both sides of the electrode accommodating portion 111 from the total length L of the battery cell 100. Meanwhile, in the case of the related art, the length L1′ of the region in which the electrode assembly 12 is installed is a value (i.e., L1′=L−2L2−2L3′) obtained by subtracting the width (L2) of the sealing portion 115 located on both sides of the electrode receiving portion 111 and the width L3′ of the electrode lead 13 from the total length (L) of the battery cell 1. Therefore, in the embodiment of the present disclosure, the length (width) (L1) of the region in which the electrode assembly 120 is installed is increased by the width (L3′) of the electrode leads 13 on both sides, compared to the related art.

Moreover, since the embodiment illustrated in FIG. 4 has a shape in which the short side sealing portion 117a is folded at least once, the length L2 of the second sealing portion 117 may be reduced, and accordingly, the length (width) L1 of the region in which the electrode assembly 120 is installed may be further increased.

On the other hand, in the embodiment of the present disclosure, since the first sealing portion 116 has a predetermined inclination angle θ with respect to the longitudinal direction of the electrode accommodating portion 111, the electrode assembly 120 is not disposed with respect to the predetermined width La and height Ha in the portion where the first sealing portion 116 is located. However, by increasing the size of the inclination angle θ to reduce the width La of the first sealing portion 116 or by reducing the height Ha of the first sealing portion 116, compared to the related art, the area in which the electrode assembly 120 is installed may be increased.

Therefore, according to an embodiment of the present disclosure, the ratio of the portion where the electrode assembly 120 is installed out of the total area (volume) in which the pouch-type battery cell 100 is installed may be increased, compared to the related art. For example, according to an embodiment of the present disclosure, the energy density per unit volume may be increased by reducing the capacity loss of the battery cell 100 compared to the related art.

In addition, according to the related art, since a space for installing a structure (bus bar support member) for insulating the bus bar is required on both electrode leads 13 for electrical connection of the electrode lead 13, capacity loss in the battery cell 1 in the length (width) direction is additionally generated. Meanwhile, according to an embodiment of the present disclosure, since the upper portion of the electrode lead 130 may be additionally utilized as a space for installing the bus bar assembly (220 in FIG. 6), the capacity loss of the battery cell 100 may be reduced.

On the other hand, in recent years, the demand for rapid charging has increased in various fields such as battery systems for electric vehicles. For rapid charging, the resistance of the battery cell 100 needs to be lowered, and to this end, the width W1 of the electrode lead 130 needs to be increased. However, in the case of the related art, the width (W2) of the electrode lead (13) should be smaller than the total height (H) of the battery cell (1). Moreover, considering the installation space of the bus bar (not illustrated) for electrical connection of the electrode lead 13, in the related art, the width W2 of the electrode lead 13 is inevitably significantly smaller than the overall height H of the battery cell 1. On the other hand, according to an embodiment of the present disclosure, the length of the first sealing portion 116 may be sufficiently increased by enabling the inclination angle θ of the first sealing portion 116 to be relatively reduced (e.g., 30 degrees or less), and the width W1 of the electrode lead 130 may also be increased. Therefore, according to an embodiment of the present disclosure, since the resistance of the electrode lead 130 may be reduced, it is advantageous for rapid charging.

Furthermore, according to the related art, since the current flow has a bent shape in a corner region B2 of the electrode assembly 12, the current flow is not smooth, and thus, there is a limit to increasing the output of the battery cell 1. However, according to an embodiment of the present disclosure, since the electrode lead 130 is installed inclined, the current flow is not broken even in the corner region B1 of the electrode assembly 120. Therefore, according to an embodiment of the present disclosure, since the current may smoothly flow, the output of the battery cell 100 may be increased and it is also effective for rapid charging.

Next, a battery cell assembly 200 according to an embodiment of the present disclosure will be described with reference to FIGS. 6 to 10.

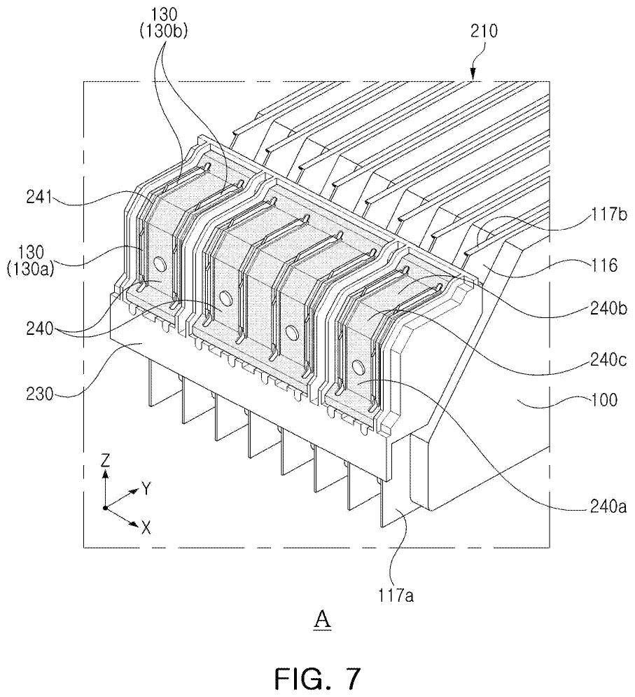

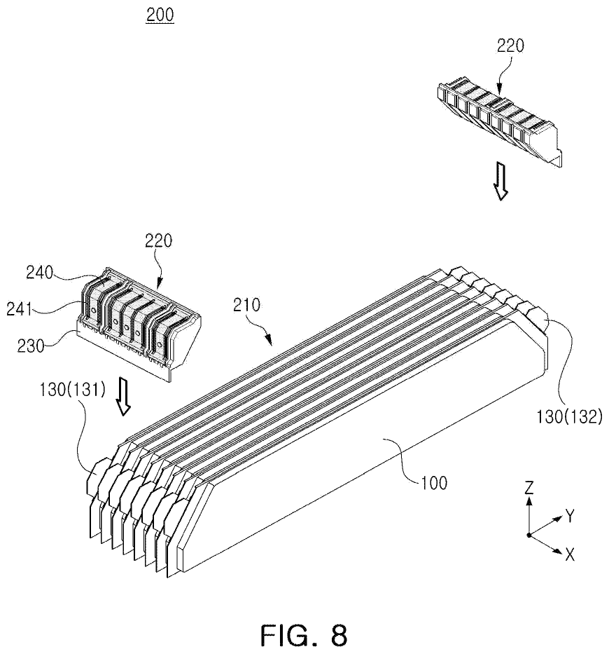

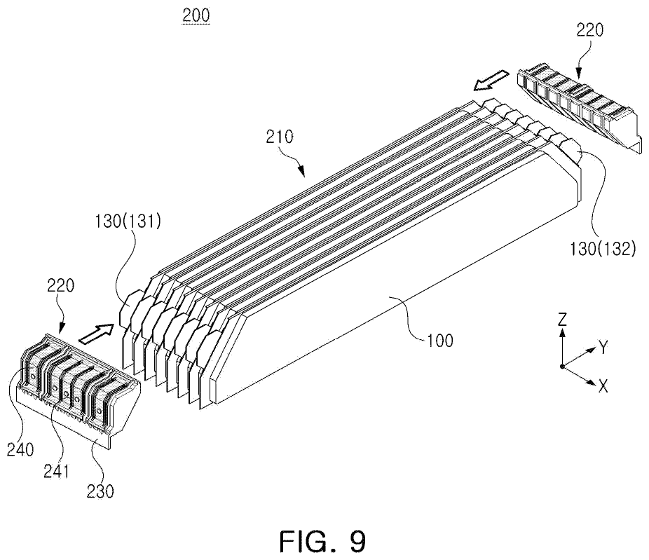

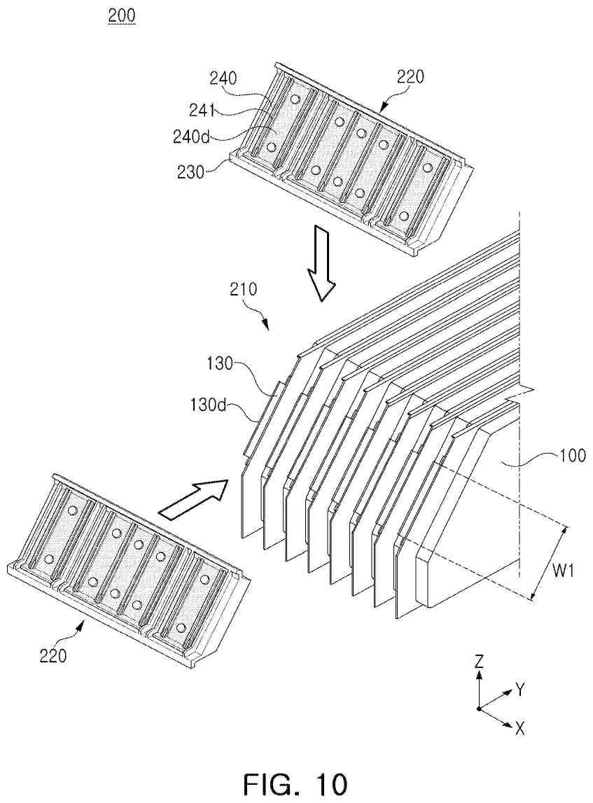

FIG. 6 is a perspective view of the battery cell assembly 200 according to an embodiment of the present disclosure, FIG. 7 is an enlarged view of portion “A” in FIG. 6, FIGS. 8 and 9 are perspective views illustrating various assembly directions of the bus bar assembly 220, and FIG. 10 is an exploded perspective view illustrating a modified example of the battery cell assembly 200 illustrated in FIG. 6.

Referring to FIGS. 6 and 7, the battery cell assembly 200 according to an embodiment of the present disclosure may include a plurality of pouch-type battery cells 100 and a bus bar assembly 220.

Since the pouch-type battery cell 100 is the same as the pouch-type battery cell 100 described with reference to FIGS. 1 to 4, detailed description thereof will be omitted. A plurality of pouch-type battery cells 100 are stacked to form a cell stack 210.

The bus bar assembly 220 has a configuration in which the plurality of pouch-type battery cells 100 are electrically connected. The bus bar assembly 220 may include at least one electrically conductive bus bar 240 electrically connected to the electrode lead 130 of the pouch-type battery cell 100, and a bus bar support member 230 supporting the at least one bus bar 240.

A coupling hole 241 through which the electrode lead 130 passes to be coupled thereto is formed in the bus bar 240. The number of coupling holes 241 corresponds to the number of pouch-type battery cells 100. The electrode lead 130 may pass through the coupling hole 241 and be welded to the bus bar 240 in a state in which the ends 130a and 130b are exposed to the outside of the bus bar 240.

The bus bar support member 230 is disposed between the bus bar 240 and the electrode accommodating portion (111 in FIG. 1) of the battery cell 100 to support the bus bar 240. A through hole (not illustrated) for passage may be formed in the bus bar support member 230. The electrode lead 130 may be welded to the bus bar 240 after passing through the through hole of the bus bar support member 230 and the coupling hole 241 of the bus bar 240.

The electrode lead 130 has a shape extending in a direction perpendicular to the inclined portion (124 in FIG. 2). At least a portion of the ends 130a and 130b of the electrode lead 130 may have a shape corresponding to the coupling surface of the bus bar 240.

Referring to FIGS. 1, 6, and 7 together, the electrode lead 130 has a first end portion 130a coupled to the coupling hole 241 while penetrating the coupling hole 241 in the first direction (Y), and a second end portion 130b coupled to the coupling hole 241 while penetrating through the coupling hole 241 in the second direction (Z). The first end 130a and the second end 130b may be connected by a connection end 130c.

Correspondingly, the bus bar 240 may include a first coupling surface 240a to which the first end portion 130a is coupled and a second coupling surface 240b to which the second end portion 130b is coupled. For example, the first coupling surface 240a is a portion through which the first end 130a penetrates in the first direction Y and is coupled thereto, and the second coupling surface 240b is a portion through which the second end 130b penetrates in the second direction Z and then is coupled thereto. The bus bar 240 may include a connection surface 240c connecting the first coupling surface 240a and the second coupling surface 240b in correspondence with the connection end 130c.

The coupling hole 241 may have a shape extending over the first coupling surface 240a and the second coupling surface 240b, such that the first end 130a and the second end 130b of the electrode lead 130 pass through the coupling hole 241. For example, the coupling hole 241 may have a shape connected to the first coupling surface 240a, the coupling surface 240c, and the second coupling surface 240b.

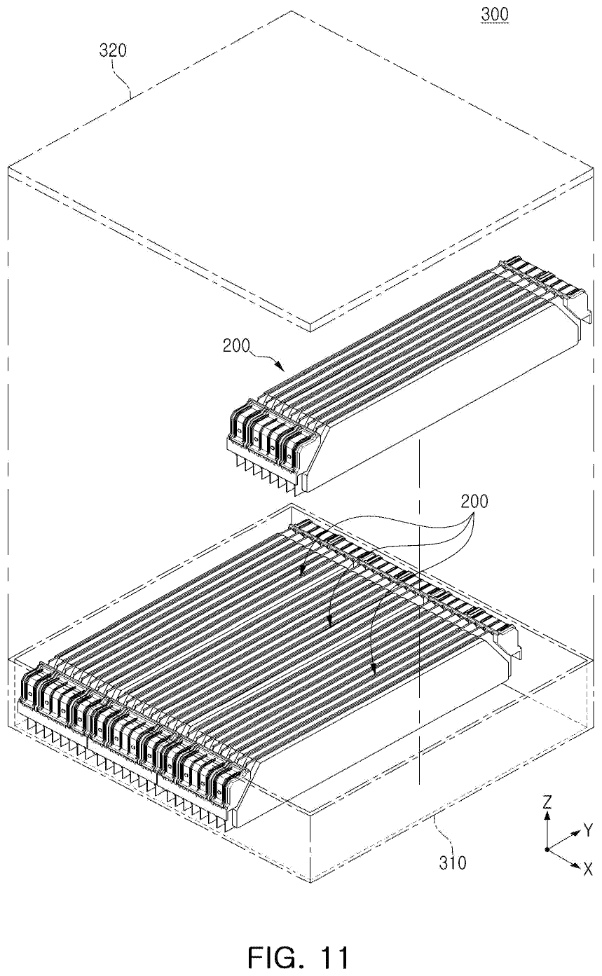

The first end 130a of the electrode lead 130 is welded to the first coupling surface 240a of the bus bar 240, and the second end 130b of the electrode lead 130 may be welded to the second coupling surface 240b of the bus bar 240. For example, the electrode lead 130 may be coupled to the bus bar 240 on a plurality of planes extending in different directions. Therefore, not only the bonding force between the electrode lead 130 and the bus bar 240 increases, but also may resist vibrations or impact in various directions. In the case of the related art, since the surface where the bus bar and the electrode lead are coupled is formed of a plane perpendicular to the bottom surface, there is a problem in which the electrode lead is separated from the bus bar or the electrode lead is damaged due to vibrations or impact of the installation object (e.g., a car). However, according to an embodiment of the present disclosure, since the bus bar 240 and the electrode lead 130 are coupled on a plurality of coupling surfaces, vibration or impact in various directions may be withstood. Therefore, according to an embodiment of the present disclosure, a phenomenon in which the electrode lead 130 is separated from the bus bar 240 or the electrode lead 130 is damaged due to vibrations or impact may be reduced. In addition, since the bonding force between the bus bar assembly 220 and the electrode lead 130 is high, handling of the battery cell assembly 200 may be facilitated. Therefore, as will be described later, a structure in which the battery cell assembly 200 is directly installed in the pack housing (310 in FIG. 11), for example, a battery pack (300 in FIG. 11) having a cell-to-pack structure may be implemented.

On the other hand, according to an embodiment of the present disclosure, since the electrode lead 130 is installed at the corner of the pouch-type battery cell 100, the degree of freedom of the bus bar assembly 220 in the coupling direction is increased to couple the bus bar 240 and the electrode lead 130. For example, the bus bar assembly 220 may be coupled to the electrode lead 130 in the second direction (Z) as illustrated in FIG. 8, and may be coupled to the electrode lead 130 in the first direction (Y) as illustrated in FIG. 9. Alternatively, the bus bar assembly 220 may be coupled to the electrode lead 130 in a direction in which the electrode lead 130 extends, for example, in a direction inclined in both the first direction Y and the second direction Z. Therefore, according to an embodiment of the present disclosure, the assemblability of the bus bar assembly 220 may be improved.

In addition, according to an embodiment, since the electrode lead 130 is installed at the corner of the pouch-type battery cell 100, the installation position of the external connection terminal (not illustrated) connected to the bus bar 240 may be changed in various manners. Therefore, according to an embodiment, the degree of freedom in designing the path and installation location of the high voltage terminal may be increased. For example, the battery cell assemblies 200 adjacent to each other are electrically connected by high voltage terminals, and according to an embodiment of the present disclosure, the connection direction or path of the high voltage terminal may be easily changed according to the detailed layout of the battery pack (300 in FIG. 11).

The battery cell assembly 200 illustrated in FIG. 10 has substantially the same configuration as the battery cell assembly 200 described with reference to FIGS. 6 to 9, except for the shape of the bus bar assembly 220 and the end shape of the electrode lead 130. Therefore, to avoid unnecessary duplication, detailed descriptions of the same or similar components will be omitted and replaced with the above description.

The battery cell assembly 200 illustrated in FIG. 10 includes a cell stack 210 in which a plurality of pouch-type battery cells 100 are stacked and a bus bar assembly 220.

The electrode lead 130 is disposed at a corner of the battery cell 100 and has a shape extending in a direction perpendicular to the inclined portion (124 in FIG. 2). The electrode lead 130 has a constant width W1 and has an inclined end portion 130d having an inclined shape in the width direction.

The bus bar assembly 220 includes a bus bar 240 and a bus bar support member 230. The bus bar 240 may include an inclined coupling surface 240d having a coupling hole 241 through which the inclined end portion 130d of the electrode lead 130 passes and is coupled thereto. The inclined coupling surface 240d may be inclined with respect to a surface perpendicular to the first direction Y and a surface perpendicular to the second direction Z, respectively. For example, the inclined coupling surface 240d may have an inclination corresponding to the inclination of the inclined end portion 130d of the electrode lead 130. For example, unnecessary ends of the electrode lead 130 may be cut while the electrode lead 130 is welded to the inclined coupling surface 240d. Accordingly, the inclined end portion 130d of the electrode lead 130 and the inclined coupling surface 240d may have substantially the same inclination.

Like the embodiments of FIGS. 8 and 9, in the embodiment illustrated in FIG. 10, the electrode lead 130 is installed at the corner of the pouch-type battery cell 100. Therefore, according to an embodiment of the present disclosure, since the bus bar assembly 220 may be coupled to the cell stack 210 in various directions, assemblability of the bus bar assembly 220 may be improved. In addition, according to an embodiment of the present disclosure, the degree of freedom in designing the path and installation location of the high voltage terminal may be increased.

In addition, according to an embodiment of the present disclosure, since the inclined coupling surface 240d of the bus bar 240 is inclined with respect to the bottom in the direction of gravity, compared to the related art, it may better withstand vibration or impact in the vertical or horizontal direction, and separation and/or damage of the electrode lead 130 may be reduced.

Finally, a battery pack 300 according to an embodiment of the present disclosure will be described with reference to FIG. 11.

FIG. 11 is an exploded perspective view of the battery pack 300 according to an embodiment of the present disclosure. Referring to FIG. 11, the battery pack 300 according to an embodiment may include a plurality of battery cell assemblies 200 and a pack housing 310 accommodating the same.

A plurality of the battery cell assemblies 200 are installed inside the pack housing 310. In the battery cell assembly 200, any one of the battery cell assemblies 200 described with reference to FIGS. 6 to 10 may be disposed.

An accommodation space for accommodating the plurality of battery cell assemblies 200 is formed in the pack housing 310. A pack cover 320 may be coupled to the pack housing 310 to cover the plurality of battery cell assemblies 200.

According to the battery pack 300 according to an embodiment of the present disclosure, since the battery cell assembly 200 is directly installed in the pack housing 310 without intervening the module housing, the energy density of the battery pack 300 may be increased.

As set forth above, according to an embodiment having the configuration above, an effect of improving energy density per unit volume may be obtained.

In addition, according to an embodiment, there is an effect that is advantageous to rapid charging.

Further, according to an embodiment, the width of the electrode lead may be increased, and the effect of improving the current flow from the electrode plate to the electrode lead may be obtained.

In addition, according to an embodiment, an effect of reducing damage to the electrode lead may be obtained.

According to an embodiment, an effect of improving the assemblability of the bus bar assembly may be obtained.

While example embodiments have been illustrated and described above, it will be apparent to those skilled in the art that modifications and variations could be made without departing from the scope of the present disclosure as defined by the appended claims.

For example, it may be implemented by deleting some components in the above-described embodiments, and each of the embodiments and modified examples may be implemented in combination with each other.

What is claimed is:

1. A pouch-type battery cell comprising:
an electrode assembly provided by stacking a plurality of electrode plates;
a pouch having an electrode accommodating portion accommodating the electrode assembly therein and a sealing portion sealing at least a portion of a circumference of the electrode accommodating portion; and
electrode leads electrically connected to the electrode assembly and exposed to an outside of the pouch through the sealing portion,
wherein the electrode leads are exposed to the outside of the pouch through a first sealing portion provided at a corner of the pouch among the sealing portion.

2. The pouch-type battery cell of claim 1, wherein the electrode assembly has an inclined portion having a chamfered shape in at least some corners, and
the electrode leads are electrically connected to the electrode assembly through the inclined portion.

3. The pouch-type battery cell of claim 1, wherein each of the plurality of electrode plates has at least six sides, including a first long side,
the pouch has a folded shape based on a portion corresponding to the first long side of the electrode assembly, and
the sealing portion is provided on a remaining portion of a circumference of the electrode assembly, except for a portion thereof corresponding to the first long side.

4. The pouch-type battery cell of claim 3, wherein each of the plurality of electrode plates includes the first long side, two short sides perpendicular to the first long side, a second long side facing the first long side, and two inclined sides connecting the second long side and the two short sides, respectively.

5. The pouch-type battery cell of claim 2, wherein each of the plurality of electrode plates has a shape in which at least a portion of corners of a quadrangle having a long side and a short side is chamfered, and
the electrode assembly includes long side parts corresponding to long sides of the plurality of electrode plates, short side parts corresponding to short sides of the plurality of electrode plates, and inclined portions connecting the long side parts and the short side parts.

6. The pouch-type battery cell of claim 5, wherein the inclined portions are disposed on both sides of one of the long side parts, respectively.

7. The pouch-type battery cell of claim 5, wherein the sealing portion includes the first sealing portion and a second sealing portion, the second sealing portion being formed corresponding to at least a portion of the long side parts and the short side parts.

8. The pouch-type battery cell of claim 7, wherein the second sealing portion includes a long side sealing portion corresponding to the long side part and a short side sealing portion corresponding to the short side part, and
the long side sealing portion is folded at least once.

9. The pouch-type battery cell of claim 8, wherein the short side sealing portion is folded at least once.

10. The pouch-type battery cell of claim 7, wherein the pouch has a folded shape based on a portion of the electrode accommodating portion, which corresponds to one of the long side parts of the electrode assembly.

11. The pouch-type battery cell of claim 7, wherein the electrode leads have a shape extending in a direction perpendicular to the inclined portions.

12. The pouch-type battery cell of claim 1, wherein the electrode accommodating portion has a shape corresponding to the electrode assembly, and
the sealing portion seals at least a portion of the circumference of the electrode accommodating portion in a shape corresponding to the electrode assembly.

13. A battery cell assembly comprising:
a plurality of pouch-type battery cells each including an electrode assembly provided by stacking a plurality of electrode plates, a pouch having an electrode accommodating portion accommodating the electrode assembly therein and a sealing portion sealing at least a portion of a circumference of the electrode accommodating portion, and electrode leads electrically connected to the electrode assembly; and
a bus bar assembly having at least one bus bar electrically connected to the electrode leads,
wherein the electrode leads are exposed to an outside of the pouch through a first sealing portion provided at a corner of the pouch among the sealing portion.

14. The battery cell assembly of claim 13, wherein the electrode assembly has an inclined portion having a chamfered shape in at least some corners, and
the electrode leads are electrically connected to the electrode assembly through the inclined portion.

15. The battery cell assembly of claim 14, wherein each of the plurality of electrode plates has a shape in which at least a portion of corners of a quadrangle having a long side extending in a first direction and a short side extending in a second direction is chamfered, and
the electrode assembly includes long side parts corresponding to long sides of the plurality of electrode plates, short side parts corresponding to short sides of the plurality of electrode plates, and inclined portions connecting the long side parts and the short side parts.

16. The battery cell assembly of claim 15, wherein the electrode leads have a shape extending in a direction perpendicular to the inclined portion.

17. The battery cell assembly of claim 16, wherein the at least one bus bar includes a coupling hole to which each of the electrode leads is coupled, and
each of the electrode leads includes a first end coupled to the coupling hole while passing through the coupling hole in the first direction, and a second end coupled to the coupling hole while passing through the coupling hole in the second direction.

18. The battery cell assembly of claim 17, wherein the bus bar includes a first coupling surface to which the first end is coupled and a second coupling surface to which the second end is coupled, and
the coupling hole has a shape extending over the first coupling surface and the second coupling surface.

19. The battery cell assembly of claim 16, wherein the at least one bus bar includes an inclined coupling surface having a coupling hole through which each of the electrode leads passes and is coupled thereto,
wherein the inclined coupling surface forms an inclination with respect to a surface perpendicular to the first direction and a surface perpendicular to the second direction, respectively.

20. A battery pack comprising:
at least one battery cell assembly; and
a pack housing having an inner space in which the at least one battery cell assembly is accommodated,
wherein each battery cell assembly comprising:
a plurality of pouch-type battery cells each including an electrode assembly provided by stacking a plurality of electrode plates, a pouch having an electrode accommodating portion accommodating the electrode assembly therein and a sealing portion sealing at least a portion of a circumference of the electrode accommodating portion, and electrode leads electrically connected to the electrode assembly; and
a bus bar assembly having at least one bus bar electrically connected to the electrode leads,
wherein the electrode leads are exposed to an outside of the pouch through a first sealing portion provided at a corner of the pouch among the sealing portion.
